(19) United States
(12) Patent Application Publication
(10) Pub. No.: US 2009/0067391 A1
(43) Pub. Date: Mar. 12, 2009

(54) Separate Rank and CQI Feedback in Wireless Networks

(76) Inventors: Zukang Shen, Richardson, TX (US); Eko Nugroho Onggosanusi, Allen, TX (US); Runhua Chen, Dallas, TX (US)

Correspondence Address: TEXAS INSTRUMENTS INCORPORATED, P O BOX 655474, M/S 3999, DALLAS, TX, 75265, US

(21) Appl. No.: 12/207,560

(22) Filed: Sep. 10, 2008

Related U.S. Application Data
(60) Provisional application No. 60/971,354, filed on Sep. 11, 2007.
(60) Provisional application No. 60/976,713, filed on Oct. 1, 2007.
(60) Provisional application No. 61/018,745, filed on Jan. 3, 2008.
(60) Provisional application No. 60/976,715, filed on Oct. 1, 2007.

(51) Int. Cl. H04J 3/00

(52) U.S. Cl. 370/336

(57) ABSTRACT

A transmission of information within a wireless network may include a first and second type of feedback information, wherein the second type of feedback information is derived based on the first type of feedback information. The first type of feedback information is embedded in a configured frame every T1 frames. The second type of feedback is embedded in a configured frame every T2 frames, wherein T1 is greater than or equal to T2. A sequence of frames is transmitted from one node in the network to a second node on an uplink control channel.

### CLAIM OF PRIORITY

This application for Patent claims priority to U.S. Provisional Application No. 60/971,354 (Attorney docket TI-65338PS) entitled “TDM Methods for Separate Rank and CQI Feedback” filed Sep. 11, 2007, which is incorporated by reference herein. This application for Patent also claims priority to U.S. Provisional Application No. 60/976,713 (Attorney docket TI-65338PS1) entitled “Separate Rank and CQI Feedback in PUCCH” filed Oct. 1, 2007, which is incorporated by reference herein. This application for patent also claims priority to U.S. Provisional Application No. 61/018,745 (Attorney docket TI-65338PS2) entitled “TDM Methods for Separate Rank and CQI Feedback” filed Jan. 3, 2008, which is incorporated by reference herein. This application for patent also claims priority to U.S. Provisional Application No. 60/976,715 (Attorney docket TI-65441PS) entitled “Simultaneous CQI and ACK/NAK Transmission in Uplink” filed Oct. 1, 2007, which is incorporated by reference herein.

### FIELD OF THE INVENTION

This invention generally relates to wireless communication, and in particular to providing feedback in orthogonal frequency division multiple access (OFDMA), DFT-spread OFDMA, and single carrier frequency division multiple access (SC-FDMA) systems.

### BACKGROUND OF THE INVENTION

Wireless cellular communication networks incorporate a number of mobile UEs and a number of NodeBs. A NodeB is generally a fixed station, and may also be called a base transceiver system (BTS), an access point (AP), a base station (BS), or some other equivalent terminology. As improvements of networks are made, the NodeB functionality evolves, so a NodeB is sometimes also referred to as an evolved NodeB (eNB). In general, NodeB hardware, when deployed, is fixed and stationary, while the UE hardware is portable.

In contrast to NodeB, the mobile UE can comprise portable hardware. User equipment (UE), also commonly referred to as a terminal or a mobile station, may be fixed or mobile device and may be a wireless device, a cellular phone, a personal digital assistant (PDA), a wireless modem card, and so on. Uplink communication (UL) refers to a communication from the mobile UE to the NodeB, whereas downlink (DL) refers to communication from the NodeB to the mobile UE. Each NodeB contains radio frequency transmitter(s) and the receiver(s) used to communicate directly with the mobiles, which move freely around it. Similarly, each mobile UE contains radio frequency transmitter(s) and the receiver(s) used to communicate directly with the NodeB. In cellular networks, the mobiles cannot communicate directly with each other but have to communicate with the NodeB.

Control information feedback bits are transmitted, for example, in the uplink (UL), for several purposes. For instance, Downlink Hybrid Automatic Repeat ReQuest (HARQ) requires at least one bit of ACK/NACK transmitted in the uplink, indicating successful or failed circular redundancy check(s) (CRC). Moreover, a one bit scheduling request indicator (SRI) is transmitted in uplink, when UE has new data arrival for transmission in uplink. Furthermore, an indicator of downlink channel quality (CQI) needs to be transmitted in the uplink to support mobile UE scheduling in the downlink. While CQI may be transmitted based on a periodic or triggered mechanism, the ACK/NACK needs to be transmitted in a timely manner to support the HARQ operation. Note that ACK/NACK is sometimes denoted as ACKNAK or just simply ACK, or any other equivalent term. As seen from this example, some elements of the control information should be provided additional protection, when compared with other information. For instance, the ACK/NACK information is typically required to be highly reliable in order to support an appropriate and accurate HARQ operation. This uplink control information is typically transmitted using the physical uplink control channel (PUCCH), as defined by the 3GPP working groups (WG), for evolved universal terrestrial radio access (EUTRA). The EUTRA is sometimes also referred to as 3GPP long-term evolution (3GPP LTE). The structure of the PUCCH is designed to provide sufficiently high transmission reliability.

To support dynamic scheduling and multiple-input multiple-output (MIMO) transmission in downlink (DL), several control information feedback bits must be transmitted in uplink. For example, MIMO related feedback information includes: Index of a selected precoding matrix (PMI); transmission rank, which is the number of spatial transmission layers; and supportable modulation and coding schemes (MCS).

In addition to PUCCH, the EUTRA standard also defines a physical uplink shared channel (PUSCH), intended for transmission of uplink user data. The Physical Uplink Shared Channel (PUSCH) can be dynamically scheduled. This means that time-frequency resources of PUSCH are re-allocated every sub-frame. This (re)allocation is communicated to the mobile UE using the Physical Downlink Control Channel (PDCCH). Alternatively, resources of the PUSCH can be allocated semi-statically, via the mechanism of persistent scheduling. Thus, any given time-frequency PUSCH resource can possibly be used by any mobile UE, depending on the scheduler allocation. Physical Uplink Control Channel (PUCCH) is different than the PUSCH, and the PUCCH is used for transmission of uplink control information (UCI). Frequency resources which are allocated for PUCCH are found at the two extreme edges of the uplink frequency spectrum. In contrast, frequency resources which are used for PUSCH are in between. Since PUSCH is designed for transmission of user data, re-transmissions are possible, and PUSCH is expected to be generally scheduled with less stand-alone sub-frame reliability than PUCCH. The general operations of the physical channels are described in the EUTRA specifications, for example: “3^{rd} Generation Partnership Project; Technical Specification Group Radio Access Network; Evolved Universal Terrestrial Radio Access (E-UTRA); Physical Channels and Modulation (TS36.211, Release 8).”

A reference signal (RS) is a pre-defined signal, pre-known to both transmitter and receiver. The RS can generally be thought of as deterministic from the perspective of both transmitter and receiver. The RS is typically transmitted in order for the receiver to estimate the signal propagation medium. This process is also known as “channel estimation.” Thus, an RS can be transmitted to facilitate channel estimation. Upon deriving channel estimates, these estimates are used for demodulation of transmitted information. This type of RS is sometimes referred to as De-Modulation RS or DM RS. Note that RS can also be transmitted for other purposes, such as channel sounding (SRS), synchronization, or any other purpose. Also note that Reference Signal (RS) can be sometimes called the pilot signal, or the training signal, or any other equivalent term.

### BRIEF DESCRIPTION OF THE DRAWINGS

Particular embodiments in accordance with the invention will now be described, by way of example only, and with reference to the accompanying drawings:

FIG. 1 is a pictorial of an illustrative telecommunications network that employs an embodiment of separate rank and CQI feedback in the physical uplink control channel (PUCCH);

FIG. 2 is an example frame structure used in the PUCCH of FIG. 1;

FIGS. 3A and 3B illustrate placement of reference symbols in the frame structure of FIG. 2;

FIGS. 4A and 4B illustrate rank and CQI feedback data embedded in the frame structure of FIG. 3;

FIG. 5 is a time plot illustrating placement of separate rank and CQI feedback in a stream of subframes at a same feedback rate;

FIG. 6 is a time plot illustrating placement of separate rank and CQI feedback in a stream of subframes at different feedback rates;

FIG. 7 is a time plot illustrating placement of separate rank and CQI feedback in a stream of subframes at different feedback rates, with the same rank repeated N times;

FIG. 8 is a time plot illustrating placement of separate rank and CQI feedback in a stream of subframes at different feedback rates, with an event triggered rank transmission;

FIG. 9 is a time plot illustrating placement of separate rank and CQI feedback in a stream of subframes at different feedback rates, with N sections of coded rank bits;

FIG. 10 is a time plot illustrating another embodiment of embedding of separate rank and CQI feedback in a resource block of a stream of subframes;

FIG. 11 is a time plot illustrating another embodiment of separate rank and CQI feedback in a resource block for several UE in a stream of subframes;

FIG. 12 is a time plot illustrating placement of separate rank and CQI feedback in a stream of subframes by modulating an RS symbol with rank information;

FIG. 13 is a block diagram of OFDMA modulation;

FIG. 14 is a block diagram of SC-OFDMA modulation;

FIG. 15 is a block diagram of a Node B and a User Equipment for use in the network system of FIG. 1; and

FIG. 16 is a block diagram of a cellular phone for use in the network of FIG. 1.

### DETAILED DESCRIPTION OF EMBODIMENTS OF THE INVENTION

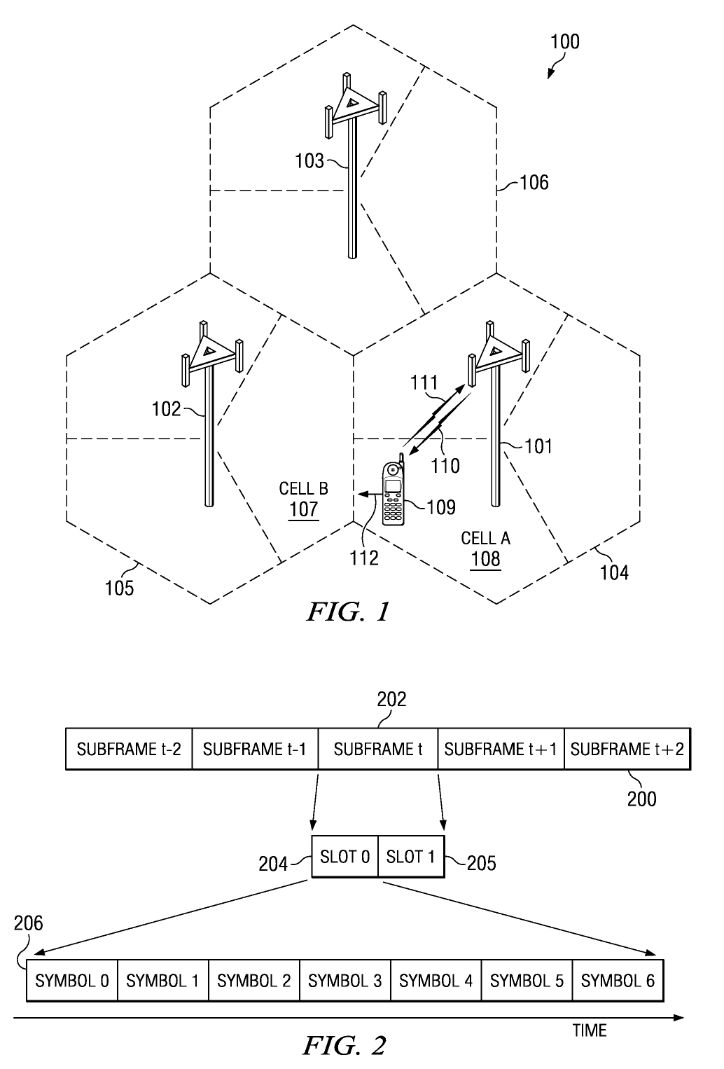

FIG. 1 shows an exemplary wireless telecommunications network 100. The illustrative telecommunications network includes representative base stations 101, 102, and 103; however, a telecommunications network necessarily includes many more base stations. Each of base stations 101, 102, and 103 are operable over corresponding coverage areas 104, 105, and 106. Each base station's coverage area is further divided into cells. In the illustrated network, each base station's coverage area is divided into three cells. Handset or other UE 109 is shown in Cell A 108, which is within coverage area 104 of base station 101. Base station 101 is transmitting to and receiving transmissions from UE 109 via downlink 110 and uplink 111. As UE 109 moves out of Cell A 108, and into Cell B 107, UE 109 may be handed over to base station 102. Because UE 109 is synchronized with base station 101, UE 109 must employ non-synchronized random access to initiate handover to base station 102.

A UE in a cell may be stationary such as within a home or office, or may be moving while a user is walking or riding in a vehicle. UE 109 moves within cell 108 with a velocity 112 relative to base station 102.

Channel quality indicator (CQI) needs to be fed back in uplink (UL) to support dynamic scheduling and multiple-input-multiple-output (MIMO) transmission on downlink (DL). In 3GPP EUTRA, if a UE (user equipment) has no uplink data transmission, its CQI is transmitted on a dedicated UL control channel (i.e. PUCCH). To support dynamic scheduling and multiple-input multiple-output transmission in downlink (DL), several control signaling must be fed back in uplink (UL). For example, MIMO related feedback information includes: index of a selected precoding matrix (PMI); transmission rank, which is the number of spatial transmission layers; and supportable modulation and coding schemes (MCS).

In this document, PMI and MCS will generally be referred to as the channel quality indicator (CQI). Note that the feedback frequency and time granularity of MIMO related information can be UE (user equipment) specific. Further, the rank feedback time granularity can be larger than CQI. Thus, it is unnecessary to transmit rank information every time CQI is fed back. On the other hand, the rank information has to be received with high reliability, because rank information determines the number of information bits contained in CQI. In other words, CQI is generated using the value of transmission rank.

Rank and CQI can be jointly coded and transmitted in UL. However, since rank information determines the length of the CQI information bits and consequently the coding scheme, blind decoding is necessary for joint rank and CQI coding, which may not provide satisfactory performance. In this disclosure, several separate rank and CQI feedback schemes based on time domain multiplexing (TDM) are described. With separate Rank and CQI transmission, one or more OFDM symbols can be exclusively dedicated for Rank transmission. Furthermore, frequency diversity can be easily achieved by repeating the Rank bits on both slots of a subframe. Although the length of the CQI information bits depends on Rank, the joint Rank and CQI transmission scheme assumes the worst (or longest) CQI length, irrespective of the Rank bits. Whenever Rank is decoded erroneously, CQI is incorrectly received. Moreover, for CQI length shorter than the worst case, some coding gains may be lost since the longest CQI length is always assumed.

Note the number of CQI information bits is dependent on Rank. For wideband MIMO related feedback in UL, Table 1 shows exemplary numbers of Rank and CQI bits for joint and separate rank and CQI transmission. For joint transmission, to avoid blind decoding at NodeB, the worst case CQI length needs to be used, irrespective of the Rank value.

TABLE 1
Number of Rank and CQI Bits per Subframe

| | 2-Tx Antennas | | 4-Tx Antennas | |
|---|---|---|---|---|
| | Rank = 1 | Rank = 2 | Rank = 1 | Rank > 1 |
| Separate rank | 1 Rank Bits | 1 Rank Bits | 2 Rank Bits | 2 Rank Bits |
| | 6 CQI Bits | 8 CQI Bits | 8 CQI Bits | 11 CQI Bits |

| | | |
|---|---|---|
| Joint, fixed (no | 9 Rank + CQI Bits | 13 Rank + CQI Bits |
| blind decoding) | | |

While the preferred rank changes with the short-term channel variation, it changes at a significantly lower rate compared to CQI. A detailed analysis is given in 3GPP R1-074150 “Rank and PMI Feedback Rate—Analysis”, October, 2007, incorporated by reference herein, where a difference of ˜5× in terms of feedback rate is observed between the rank and CQI reports. The feedback interval for rank report is in the order of 10 ms to 100 ms. This is mainly because the variation in the channel condition number is slower than the variation of the channel coefficients themselves. In addition, the rank report holds for the entire system bandwidth. This motivates a rank feedback separate from CQI. A total range in difference between the rank feedback rate and the CQI feedback rank may be in the order of two to thirty-two times.

FIG. 2 is an example frame structure 200 used in the PUCCH of FIG. 1. Each frame 200 contains several subframes, as indicated generally at 202. In turn, subframe 202 contains two slots 204, 205. Each slot contains a number of information carrying symbols, generally indicated at 206. A cyclic protection (CP) field is also appended to each symbol in order to improve reception integrity. In the current E-URTA standard, each slot contains seven symbols 206 if a normal CP length is used or six symbols 206 if an extended CP length is used. Other embodiments of the invention may provide other frame structures than the exemplary frame structure illustrated in FIG. 2. With QPSK modulation, 20 coded CQI bits are available per UE within one subframe. Further, with CDM (code division multiplexing) through cyclic shifted CAZAC-like sequences, multiple CQI UEs can be multiplexed on one resource block (RB). Ideally, 12 CQI UEs can be supported within one RB. However, due to spillover between consecutive cyclic shifts, it is recommended that not all 12 cyclic shifts are utilized.

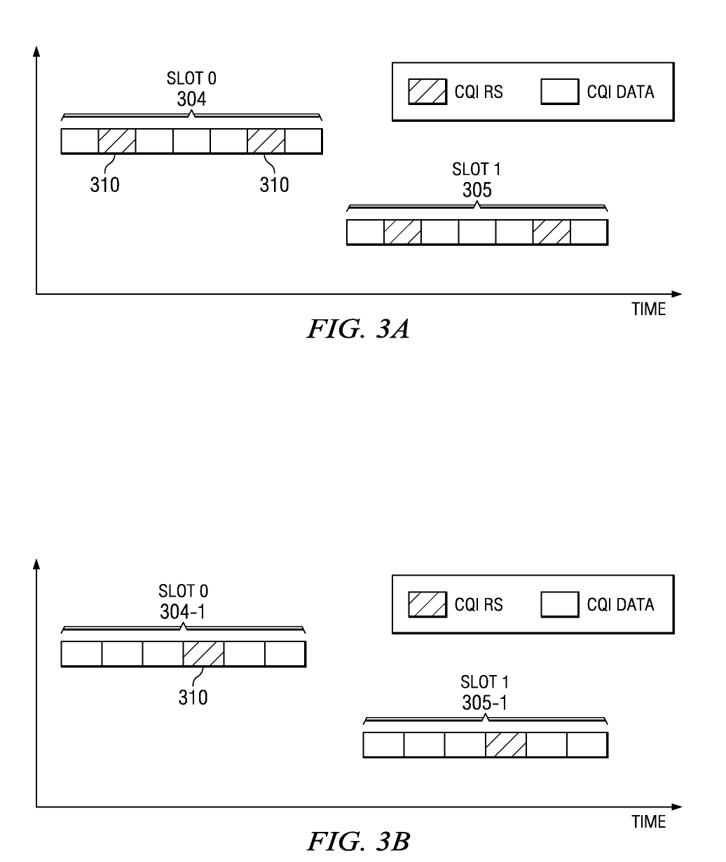

FIGS. 3A and 3B illustrate placement of reference signal symbols 310 in the frame structure of FIG. 2. As discussed above, FIG. 3A illustrates a subframe with two slots 304, 305 in the normal CP case. Two reference symbols (RS) 310 are included within each slot. FIG. 3B illustrates a subframe with two slots 304-1, 305-1 in the extended CP case. In this case, only one reference symbol 310 is included in each slot.

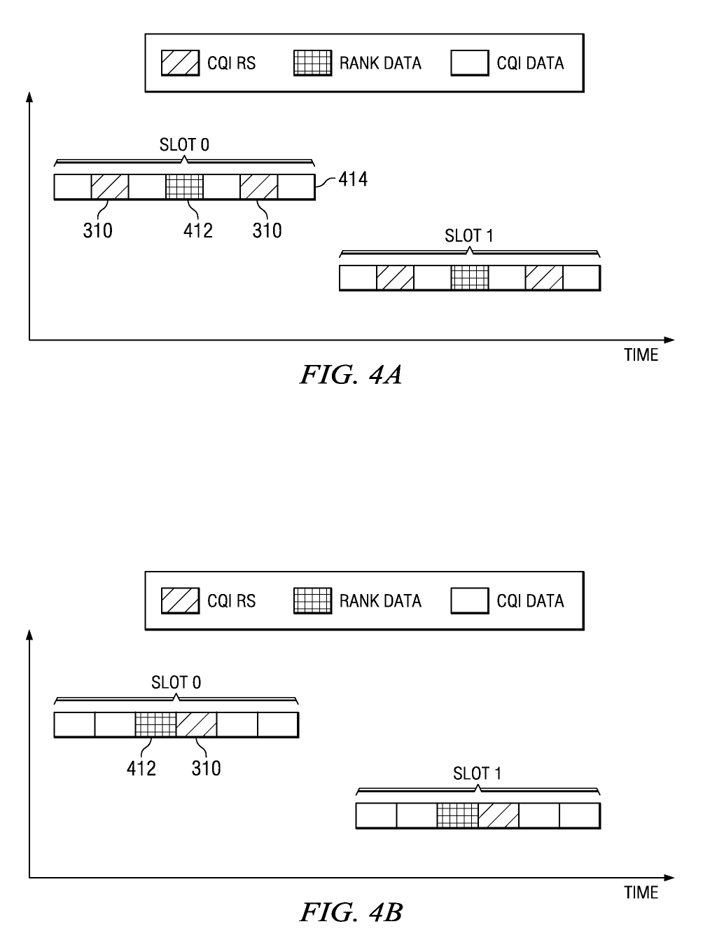

FIGS. 4A and 4B illustrate rank 412 and CQI feedback data indicated generally at 414 embedded in the frame structure of FIG. 3. The rank feedback is generally one or two bits of information, while the CQI feedback is generally 6-11 bits of information. Thus, it takes several symbols to hold the CQI feedback while a single symbol can hold the rank feedback, depending on the modulation constellation chosen. FIG. 4a illustrates slots with a normal CP in which rank feedback 412 is embedded in the fourth symbol, between RS 310 in order to improve the reception reliability of rank feedback 412. Similarly, FIG. 4B illustrates slots with extended CP in which rank feedback 412 is embedded in the third symbol adjacent RS 310 for best reception reliability. Other embodiments may chose to locate the rank feedback in a different symbol than illustrated herein.

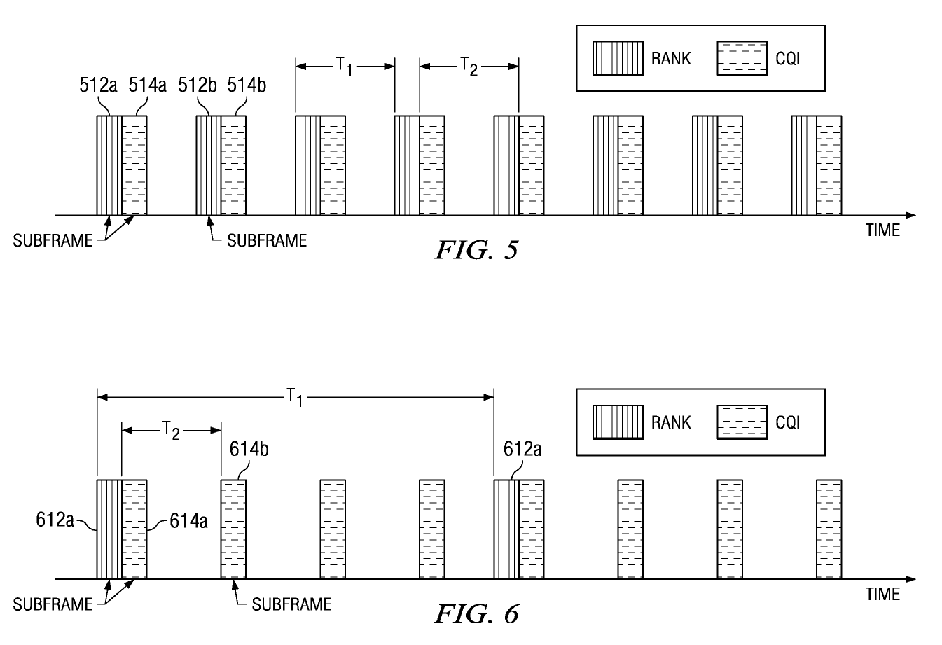

FIGS. 5 and 6 are time plots illustrating placement of separate rank and CQI feedback in a stream of subframes. In this scheme, for one UE, separate rank and CQI feedback is multiplexed in time domain on the subframe level. FIG. 5 shows an example where rank 512a, 512b is fed back as frequently as CQI 514a, 514b, whereas FIG. 6 shows an example where rank 612a, 612b is fed back less frequently than CQI 614a, 614b, as indicated by T₁ and T₂. Since rank changes much slower than CQI, it is clear that the same rank information is repeated a multiple times in FIG. 5, which amounts to unnecessary system overhead. Denote T₁ as the periodicity of rank feedback and T₂ as the periodicity of CQI feedback. Note that T₁ and T₂ can be expressed in the unit of subframe. Since rank can be fed back less frequently than CQI, then T₁≧T₂. In FIG. 6, T₁ is greater than T₂, while in FIG. 5 T₁=T₂. Note it is not necessary that rank and CQI are transmitted in consecutive subframes. Also, as illustrated in FIGS. 4A and 4B, rank and CQI bits may be transmitted in the same subframe or in different subframes.

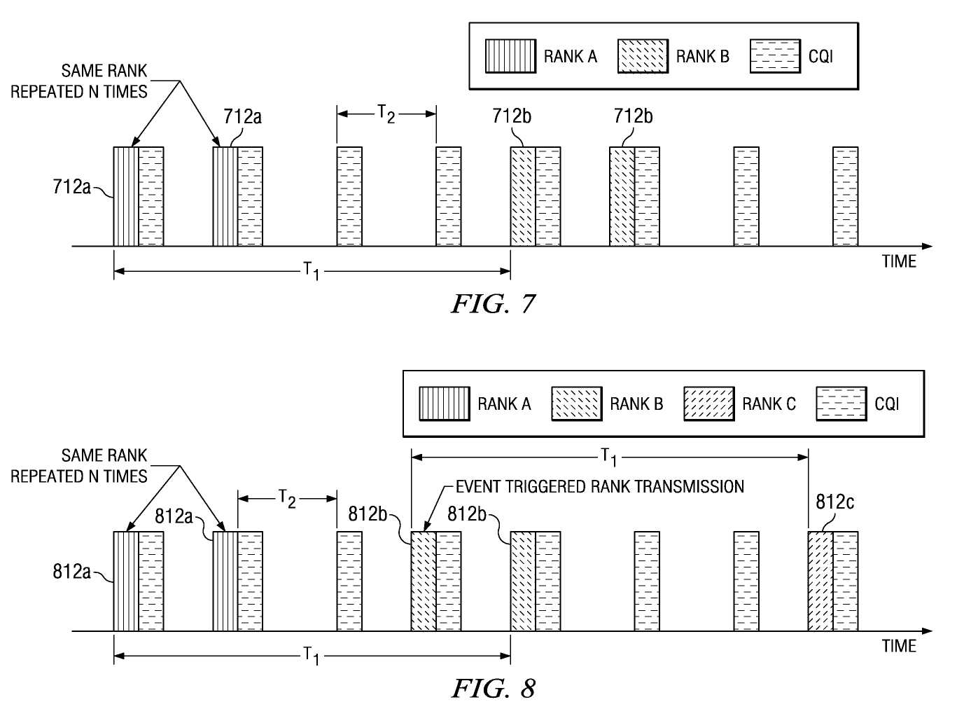

FIG. 7 is a time plot illustrating placement of separate rank and CQI feedback in a stream of subframes at different feedback rates, with the same rank 712a or 712b repeated N times. The same piece of rank information is transmitted N times at the beginning of every T₁ subframes, after which, no rank information is transmitted within the remaining of the T₁ subframes. A special case is N=1, which means rank information is only transmitted once every T₁ subframes. This amounts to a least amount of signaling overhead if the rank transmission can be very reliable. However, since the CQI coding scheme (hence the decoding scheme) depends on the rank information, it may be necessary to improve the rank transmission reliability, e.g. by repeated transmissions.

Note that T₁ and T₂ are configured by NodeB, typically depending on its estimate of the UE speed. Furthermore, N is configured by NodeB, which can be common to all UEs in a cell, or NodeB, or even the complete system or be UE specific. NodeB can inform the UE the values of T₁, T₂, and N through downlink control channels, downlink broadcast channels, or other downlink channels.

FIG. 8 is a time plot illustrating placement of separate rank and CQI feedback in a stream of subframes at different feedback rates, with an event triggered rank transmission. Occasionally, NodeB may explicitly request a transmission of rank and/or CQI after rank transmission 812a in the middle of the rank and/or CQI transmission period. In such event triggered rank and CQI transmission, the rank information is transmitted N times, as indicated at 812b, immediately after UE receives the command from NodeB for an event triggered rank and/or CQI reporting. The next rank feedback 812c is transmitted after time period T₁.

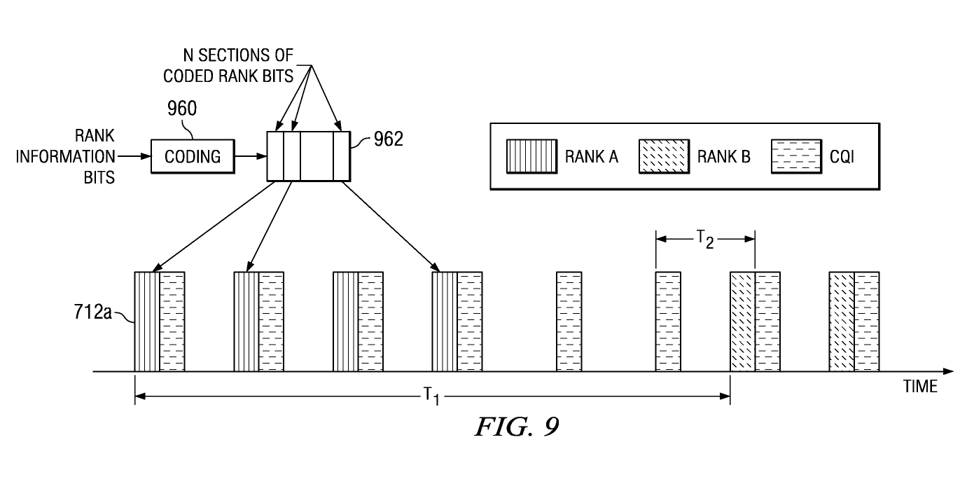

FIG. 9 is a time plot illustrating placement of separate rank and CQI feedback in a stream of subframes at different feedback rates, with N sections of coded rank bits. Since the rank information can be transmitted N times, it is possible to apply a coding scheme other than simple repetition coding to the rank information. For example, let N₁ denote the length of rank information bits and N₂ denote the number of coded bits 962 that can be transmitted on N subframes to convey the rank information. Thus, a (N₁, N₂) block coding scheme 960 can be applied. It is not precluded that other coding schemes (e.g. convolutional coding, etc.) can be applied to rank information bits. Furthermore, the proposed scheme applies to either joint or separate rank/CQI coding (or transmission).

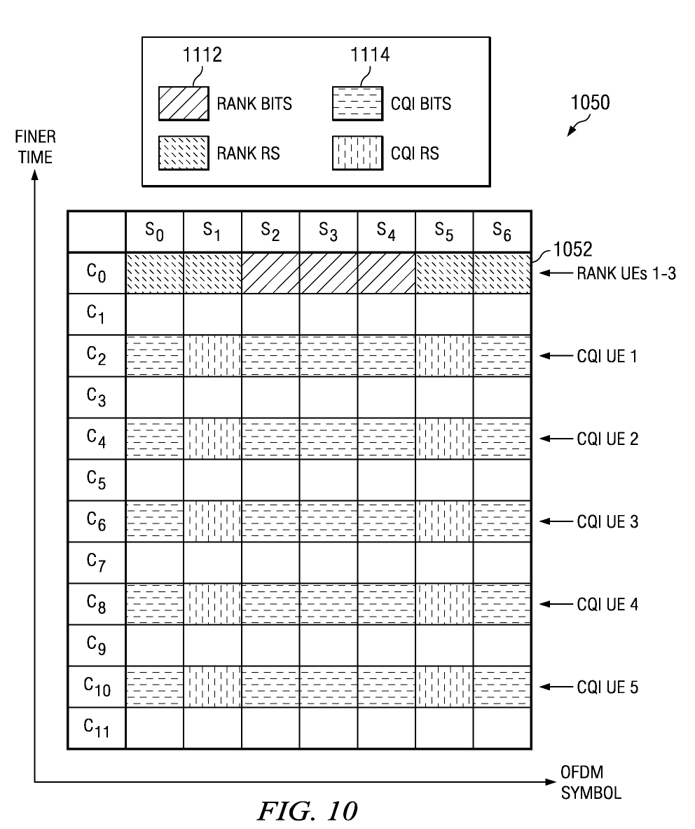

FIG. 10 is a time plot illustrating another embodiment of placement of separate rank and CQI feedback in a resource block 1050 of a stream of subframes. FIG. 10 shows an example of multiplexing rank and CQI transmissions within one slot, where C₀-C₁₁ represent the 12 cyclic shifts of a CAZAC-like sequence per resource block and S₀-S₆ denote the seven OFDM symbols per slot. Typically, the number of rank information bits is small, e.g. one or two rank information bits. Thus, block spreading across rank data symbols (and rank reference signal symbols) can be applied to improve the coverage as well as rank multiplexing capacity. For example, in FIG. 10, one cyclic shift, i.e. C₀ 1052, is assigned to rank UEs. With block spreading, up to three rank UEs, as indicated at 1112, can be allocated on C₀ 1052. On the other hand, CQI consists of multiple information bits, which prevents the application of block spreading within a slot. Consequently, on each CQI cyclic shift, only one CQI UE can be allocated, as indicated at 1114. FIG. 10 shows an example where five CQI UEs are assigned in one resource block. Note that with this embodiment of separate rank and CQI transmission, the three rank UEs are different from the five CQI UEs, as no UE is allowed to transmit rank and CQI in the same subframe. Furthermore, the same rank information may or may not be repeated in the second slot within the subframe.

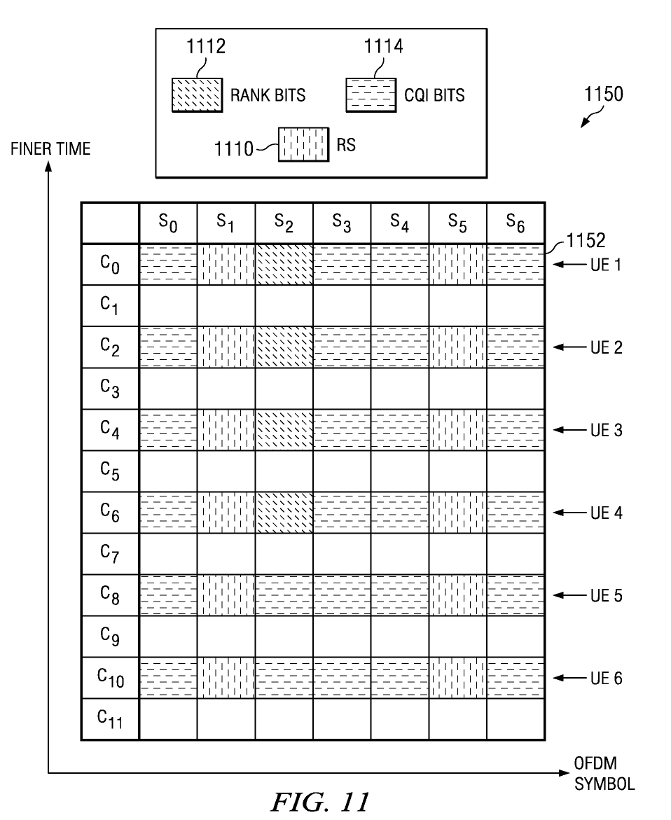

FIG. 11 is a time plot illustrating another embodiment of embedding separate rank and CQI feedback in a resource block 1150 for several UE in a stream of subframes. In this scheme, rank and CQI of one UE is multiplexed in time domain within a slot. FIG. 11 illustrates the principle. Two reference signals (RS), indicated by 1110, are placed in the 2^{nd} and 6^{th} OFDM symbol for each UE for coherent demodulation. The 3^{rd} OFDM symbol is used exclusively for rank transmission, whereas the remaining OFDM symbols (i.e. the 1^{st}, 4^{th}, 5^{th}, and 7^{th}) are used for CQI transmission, as indicated by 1114. Note that only one UE is allocated per usable cyclic shift, as indicated generally at C₀ 1152 for UE1. Moreover, note that the placement of rank symbol in FIG. 11 is exemplary. That is, any of the five available OFDM symbols can be used for rank transmission in normal CP with seven OFDM symbols per slot or in extended CP with six OFDM symbols and only one RS. Furthermore, more OFDM symbols can be assigned for rank transmission to improve the reliability of rank detection. It is not precluded that the number and position of rank OFDM symbols can be common to all UEs or UE specific. In case a UE has no rank information to transmit, all available OFDM symbols other than the ones for RS transmission can be used for CQI transmission. Examples of such case are given in FIG. 11 as UE 5 and UE 6.

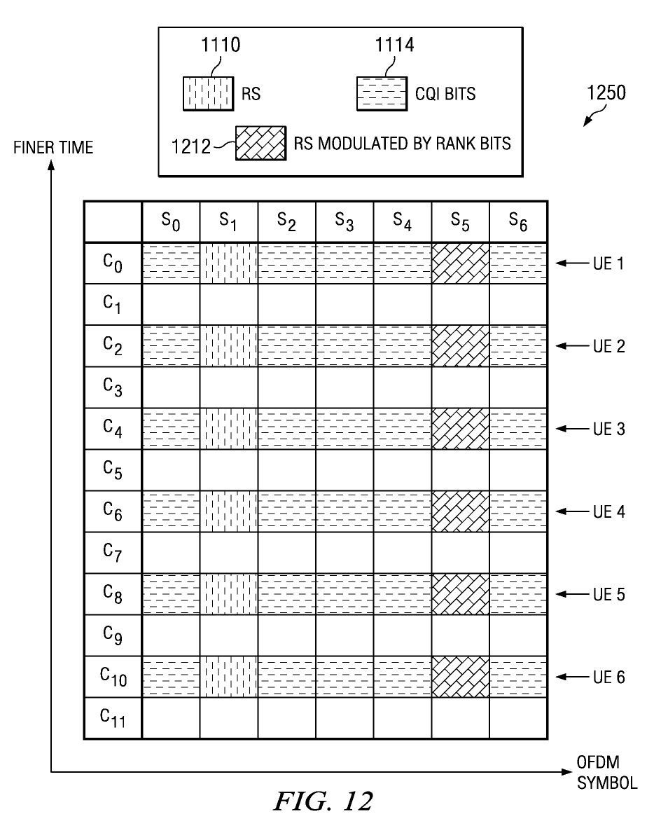

FIG. 12 is a time plot illustrating placement of separate rank and CQI feedback in a stream of subframes 1250 by modulating an RS symbol with rank information. In this embodiment of separate rank and CQI transmission, the rank bit can be embedded in one of the CQI RS OFDM symbols, as indicted at 1212. FIG. 12 shows an example where the rank information bits 1212 are embedded in the second CQI RS OFDM symbol per slot. One way to piggyback the rank information bits on CQI RS is to modulate the CQI RS with some quadrature amplitude modulation (QAM) mapping scheme. The produced constellation point mapped from the rank information is transmitted in at least one RS symbol by multiplying the RS symbol with the selected constellation point. It is not precluded that the rank information is mapped to a multiple of constellation points, each of which is transmitted in one RS symbol by multiplying the reference signal with the corresponding constellation point.

For example, with 1-bit rank, the CQI RS can be modulated by binary phase shift keying (BPSK) (i.e. 1 or −1) or rotated BPSK. For 2-bit rank, the CQI RS can be modulated by QPSK (quaternary phase shift keying) symbols. It is not precluded that the CQI RS position for carrying the rank bit(s) can be common to all UEs or be UE specific. If a UE has no rank but CQI to transmit, then the CQI RS (the one supposed to carry to rank bits) is not modulated by QAM symbol. Alternatively, in this case, the CQI RS symbol can be modulated by a default QAM symbol. CQI bits 1114 and the other CQI RS 1110 are transmitted as described earlier.

Another embodiment of embedding Rank bits in CQI RS is to convey the Rank bits in the cyclic shifts of a CQI RS. Tables 2 and 3 show some examples of transmitting 1 Rank bit, while Tables 4 and 5 show examples for 2 Rank bits.

Assuming six CQI UEs exist in one resource block, each CQI UE can be assigned with two cyclic shifts in the CQI RS symbols to carry the Rank bits. Without loss of generality, the two cyclic shifts of a UE in the CQI RS symbols are denoted as CS1_{CQI,RS} and CS2_{CQI,RS}.

TABLE 2
1 Rank Bit, Mapping Scheme 1

| | CS1_{CQI,RS} | | | | CS2_{CQI,RS} | | | |
|---|---|---|---|---|---|---|---|---|
| Rank | Slot 0 | | Slot 1 | | Slot 0 | | Slot 1 | |
| (A₁) | CQI RS 1 | CQI RS 2 | CQI RS 1 | CQI RS 2 | CQI RS 1 | CQI RS 2 | CQI RS 1 | CQI RS 2 |
| (0) | 1 | 1 | 1 | 1 | 0 | 0 | 0 | 0 |
| (1) | 0 | 0 | 0 | 0 | 1 | 1 | 1 | 1 |

TABLE 3
1 Rank Bit, Mapping Scheme 2

| | CS1_{CQI,RS} | | | | CS2_{CQI,RS} | | | |
|---|---|---|---|---|---|---|---|---|
| Rank | Slot 0 | | Slot 1 | | Slot 0 | | Slot 1 | |
| (A₁) | CQI RS 1 | CQI RS 2 | CQI RS 1 | CQI RS 2 | CQI RS 1 | CQI RS 2 | CQI RS 1 | CQI RS 2 |
| (0) | 0 | 0 | 0 | 0 | 1 | 1 | 1 | 1 |
| (1) | 1 | 1 | 1 | 1 | 0 | 0 | 0 | 0 |

TABLE 4
2 Rank Bits, Mapping Scheme 1

| | CS1_{CQI,RS} | | | | CS2_{CQI,RS} | | | |
|---|---|---|---|---|---|---|---|---|
| Rank | Slot 0 | | Slot 1 | | Slot 0 | | Slot 1 | |
| (A₁A₂) | CQI RS 1 | CQI RS 2 | CQI RS 1 | CQI RS 2 | CQI RS 1 | CQI RS 2 | CQI RS 1 | CQI RS 2 |
| (00) | 1 | 1 | 1 | 1 | 0 | 0 | 0 | 0 |
| (01) | 1 | −1 | 1 | −1 | 0 | 0 | 0 | 0 |
| (10) | 0 | 0 | 0 | 0 | 1 | 1 | 1 | 1 |
| (11) | 0 | 0 | 0 | 0 | 1 | −1 | 1 | −1 |

TABLE 5
2 Rank Bits, Mapping Scheme 2

| | CS1_{CQI,RS} | | | | CS2_{CQI,RS} | | | |
|---|---|---|---|---|---|---|---|---|
| Rank | Slot 0 | | Slot 1 | | Slot 0 | | Slot 1 | |
| (A₁A₂) | CQI RS 1 | CQI RS 2 | CQI RS 1 | CQI RS 2 | CQI RS 1 | CQI RS 2 | CQI RS 1 | CQI RS 2 |
| (00) | 0 | 0 | 0 | 0 | 1 | 1 | 1 | 1 |
| (01) | 0 | 0 | 0 | 0 | 1 | −1 | 1 | −1 |
| (10) | 1 | 1 | 1 | 1 | 0 | 0 | 0 | 0 |
| (11) | 1 | −1 | 1 | −1 | 0 | 0 | 0 | 0 |

The “0”s, “1”s, or “−1”s are used to modulate the CQI RS. “0” means the CQI RS of the corresponding cyclic shift is not used.

Note the two cyclic shifts of the CQI RS assigned to one UE are UE specific. Let CS_{CQI,data}(k) denote the cyclic shift assigned to CQI UE k for the CQI data transmission. It is recommended that the cyclic shifts of the CQI RS assigned to UE k have the following property:

CS1_{CQI,RS}(k)=CS_{CQI,data}(k)

CS2_{CQI,RS}(k)=mod(CS_{CQI,data}(k)+1, 12)

where 0≦CS_{CQI,data}(k)≦11.

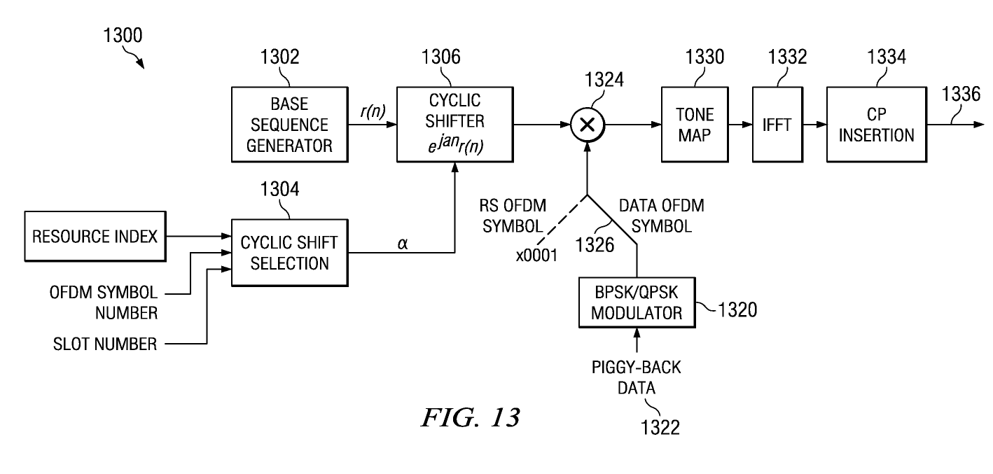

FIG. 13 is a block diagram of an illustrative orthogonal frequency-division multiplexing (OFDM) system transmitter 1300 for transmitting the frame structures of FIGS. 2-12. Elements of the transmitter may be implemented as components in a fixed or programmable processor by executing instructions stored in memory. The UE generates a CAZAC-like (e.g. ZC or extended ZC or zero-autocorrelation QPSK computer-generated) sequence using base sequence generator 1302. A cyclic shift value is selected for each symbol based on the resource index, the OFDM symbol number and the slot number in cyclic shift selecting module 1304. The base sequence is then shifted by cyclic shifter 1306 on a symbol by symbol basis using shift values provided by cyclic shift selection module 1304.

The separate rank and CQI feedback data per OFDM symbol is organized as either one or two bits in this embodiment and is input to modulator block 1320. The data bearing OFDM symbols are binary phase shift key (BPSK) or quadrature phase shift key (QPSK) modulated when the data information is one or two bits wide, respectively. The switch 1326 selects, based on the OFDM symbol type (data or RS), either the complex BPSK/QPSK constellation point or “1” as input to the complex multiplier 1324.

The result of the element-wise complex multiplication is mapped onto a designated set of tones (sub-carriers) using the Tone Map 1330. The UE next performs IFFT of the mapped signal using the IFFT 1332. A cyclic prefix is created and added in module 1334 to form a final fully formed uplink signal 1336.

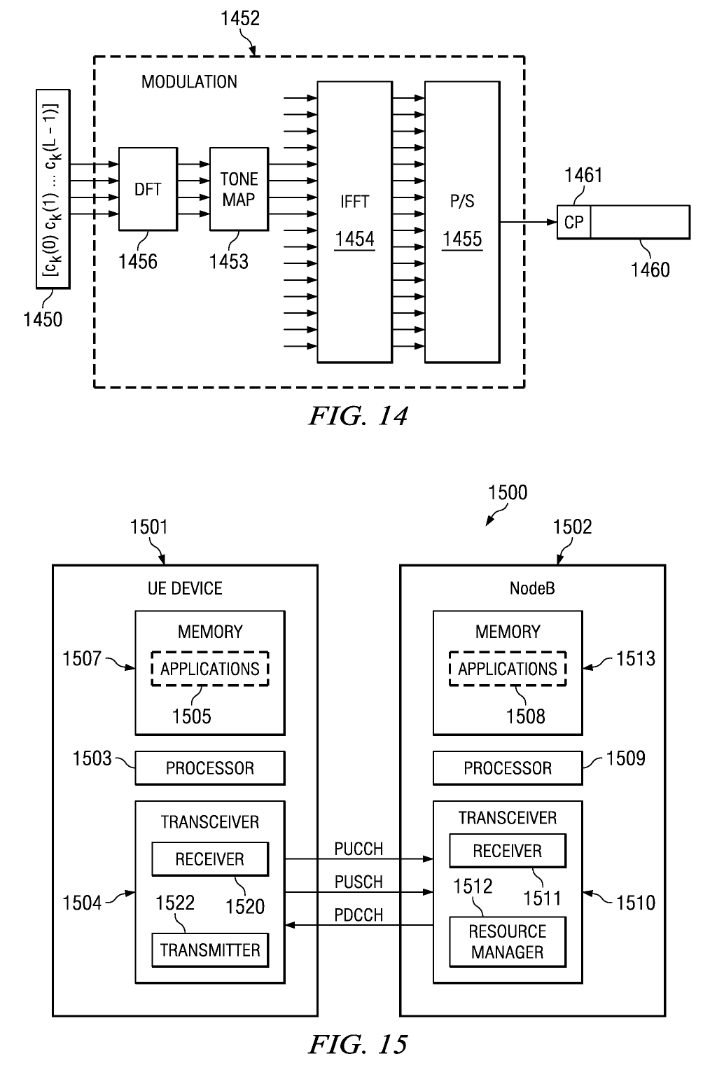

FIG. 14 illustrates an alternate modulation block 1452 to that of FIG. 13. Block [cₖ(0) . . . cₖ(L-1)] 1450 denotes the user signal of user k that includes separate rank and CQI feedback as described above. This user signal includes but not limited to reference signal, data signal and control signal. Modulation block 1452 includes discrete Fourier Transform (DFT) block 1456, tone map 1453, inverse Fast Fourier transform (IFFT) block 1454 and parallel-to-serial (P/S) converter 1455. In FIG. 14, the user signal is first processed by DFT block 1456. Tone map 1453 maps the user signal onto L sub-carriers as described above in conjunction with FIG. 13. IFFT block 1454 converts these signals from frequency domain to temporal domain. Copies of modulation block 1452 in FIG. 14 can service a plurality of UEs. The plural signals from the plural UEs are transmitted on different sub-carriers at the same time period as designated by a UE specific tone map 1453. Such a system is sometimes called single carrier orthogonal frequency division multiple access (SC-OFDMA) system. These plural user signals, DFT blocks and tone maps are omitted for clarity. P/S converter 1456 converts these parallel signals into a single serial signal 1460. A cyclic prefix (CP) 1461 is inserted by repeating a portion of the serial signal.

One embodiment of the CAZAK like signal from generator 1302 in FIG. 13 is a cyclically shifted or phase ramped CAZAC-like sequence. In this disclosure, a CAZAC-like sequence generally refers to any sequence that has the property of constant amplitude zero auto correlation. Examples of CAZAC-like sequences includes but not limited to, Chu Sequences, Frank-Zadoff Sequences, Zadoff-Chu (ZC) Sequences, Generalized Chirp-Like (GCL) Sequences, or any computer generated CAZAC sequences. One example of a CAZAC-like sequence r̅_{u,v}(n) is given by

r̅_{u,v}(n)=e^{jφ(n)π/4}, 0≦n≦M_{sc}^{RS}−1

where M_{sc}^{RS}=12 and φ(n) is defined in Table 6.

In this disclosure, the cyclically shifted or phase ramped CAZAC-like sequence is sometimes denoted as cyclic shifted base sequence, cyclic shifted root sequence, phase ramped base sequence, phase ramped root sequence, or any other equivalent term.

TABLE 6
Definition of φ(n)

| u | φ(0), . . . , φ(11) | | | | | | | | | | | |
|---|---|---|---|---|---|---|---|---|---|---|---|---|
| 0 | −1 | 1 | 3 | −3 | 3 | 3 | 1 | 1 | 3 | 1 | −3 | 3 |
| 1 | 1 | 1 | 3 | 3 | 3 | −1 | 1 | −3 | −3 | 1 | −3 | 3 |
| 2 | 1 | 1 | −3 | −3 | −3 | −1 | −3 | −3 | 1 | −3 | 1 | −1 |
| 3 | −1 | 1 | 1 | 1 | 1 | −1 | −3 | −3 | 1 | −3 | 3 | −1 |
| 4 | −1 | 3 | 1 | −1 | 1 | −1 | −3 | −1 | 1 | −1 | 1 | 3 |
| 5 | 1 | −3 | 3 | −1 | −1 | 1 | 1 | −1 | −1 | 3 | −3 | 1 |
| 6 | −1 | 3 | −3 | −3 | −3 | 3 | 1 | −1 | 3 | 3 | −3 | 1 |
| 7 | −3 | −1 | −1 | −1 | 1 | −3 | 3 | −1 | 1 | −3 | 3 | 1 |
| 8 | 1 | −3 | 3 | 1 | −1 | −1 | −1 | 1 | 1 | 3 | −1 | 1 |
| 9 | 1 | −3 | −1 | 3 | 3 | −1 | −3 | 1 | 1 | 1 | 1 | 1 |
| 10 | −1 | 3 | −1 | 1 | 1 | −3 | −3 | −1 | −3 | −3 | 3 | −1 |
| 11 | 3 | 1 | −1 | −1 | 3 | 3 | −3 | 1 | 3 | 1 | 3 | 3 |
| 12 | 1 | −3 | 1 | 1 | −3 | 1 | 1 | 1 | −3 | −3 | −3 | 1 |
| 13 | 3 | 3 | −3 | 3 | −3 | 1 | 1 | 3 | −1 | −3 | 3 | 3 |
| 14 | −3 | 1 | −1 | −3 | −1 | 3 | 1 | 3 | 3 | 3 | −1 | 1 |
| 15 | 3 | −1 | 1 | −3 | −1 | −1 | 1 | 1 | 3 | 1 | −1 | −3 |
| 16 | 1 | 3 | 1 | −1 | 1 | 3 | 3 | 3 | −1 | −1 | 3 | −1 |
| 17 | −3 | 1 | 1 | 3 | −3 | 3 | −3 | −3 | 3 | 1 | 3 | −1 |
| 18 | −3 | 3 | 1 | 1 | −3 | 1 | −3 | −3 | −1 | −1 | 1 | −3 |
| 19 | −1 | 3 | 1 | 3 | 1 | −1 | −1 | 3 | −3 | −1 | −3 | −1 |
| 20 | −1 | −3 | 1 | 1 | 1 | 1 | 3 | 1 | −1 | 1 | −3 | −1 |
| 21 | −1 | 3 | −1 | 1 | −3 | −3 | −3 | −3 | −3 | 1 | −1 | −3 |
| 22 | 1 | 1 | −3 | −3 | −3 | −3 | −1 | 3 | −3 | 1 | −3 | 3 |
| 23 | 1 | 1 | −1 | −3 | −1 | −3 | 1 | −1 | 1 | 3 | −1 | 1 |
| 24 | 1 | 1 | 3 | 1 | 3 | 3 | −1 | 1 | −1 | −3 | −3 | 1 |
| 25 | 1 | −3 | 3 | 3 | 1 | 3 | 3 | 1 | −3 | −1 | −1 | 3 |
| 26 | 1 | 3 | −3 | −3 | 3 | −3 | 1 | −1 | −1 | 3 | −1 | −3 |
| 27 | −3 | −1 | −3 | −1 | −3 | 3 | 1 | −1 | 1 | 3 | −3 | −3 |
| 28 | −1 | 3 | −3 | 3 | −1 | 3 | 3 | −3 | 3 | 3 | −1 | −1 |
| 29 | 3 | −3 | −3 | −1 | −1 | −3 | −1 | 3 | −3 | 3 | 1 | −1 |

The sequence in different data symbols in FIG. 2 can be different. In one embodiment, the sequences in different data symbols are cyclic shifted or phase ramped ZACAC-like sequences of a base sequence, with different amounts of cyclic shifts or phase ramps on different data symbols.

In 3GPP EUTRA UL, single carrier OFDMA (SC-OFDMA) is adopted as the transmission scheme due to its low peak-to-average ratio (PAR) or cubic metric (CM) property. In the context of CQI transmission on PUCCH, SC-OFDMA essentially means a UE can only transmit on one cyclic shift at each OFDM symbol to keep the PAR/CM low. For example, in FIG. 10, each UE is assigned with one usable cyclic shift per OFDM symbol.

### SYSTEM EXAMPLES

FIG. 15 is a block diagram illustrating operation of an eNB and a mobile UE in the network system of FIG. 1. As shown in FIG. 15, wireless networking system 1500 comprises a mobile UE device 1501 in communication with an eNB 1502. The mobile UE device 1501 may represent any of a variety of devices such as a server, a desktop computer, a laptop computer, a cellular phone, a Personal Digital Assistant (PDA), a smart phone or other electronic devices. In some embodiments, the electronic mobile UE device 1501 communicates with the eNB 1502 based on a LTE or E-UTRAN protocol. Alternatively, another communication protocol now known or later developed can be used.

As shown, the mobile UE device 1501 comprises a processor 1503 coupled to a memory 1507 and a Transceiver 1504. The memory 1507 stores (software) applications 1505 for execution by the processor 1503. The applications 1505 could comprise any known or future application useful for individuals or organizations. As an example, such applications 1505 could be categorized as operating systems (OS), device drivers, databases, multimedia tools, presentation tools, Internet browsers, e-mailers, Voice-Over-Internet Protocol (VOIP) tools, file browsers, firewalls, instant messaging, finance tools, games, word processors or other categories. Regardless of the exact nature of the applications 1505, at least some of the applications 1505 may direct the mobile UE device 1501 to transmit UL signals to the eNB (base-station) 1502 periodically or continuously via the transceiver 1504. In at least some embodiments, the mobile UE device 1501 identifies a Quality of Service (QoS) requirement when requesting an uplink resource from the eNB 1502. In some cases, the QoS requirement may be implicitly derived by the eNB 1502 from the type of traffic supported by the mobile UE device 1501. As an example, VOIP and gaming applications often involve low-latency uplink (UL) transmissions while High Throughput (HTP)/Hypertext Transmission Protocol (HTTP) traffic can involve high-latency uplink transmissions.

Transceiver 1504 includes uplink logic which may be implemented by execution of instructions that control the operation of the transceiver. Some of these instructions may be stored in memory 1507 and executed when needed. As would be understood by one of skill in the art, the components of the Uplink Logic may involve the physical (PHY) layer and/or the Media Access Control (MAC) layer of the transceiver 1504. Transceiver 1504 includes one or more receivers 1520 and one or more transmitters 1522 for MIMO operation, as described above. The transmitter(s) may be embodied as described with respect to FIGS. 2-14. In particular, as described above, a transmission signal comprises at least one data symbol and at least one RS symbol. An exemplary transmission signal comprising five data symbols and two RS symbols is shown in FIG. 2. Rank indicator and CQI feedback information are separately embedded in at least two different data symbols, as described above. The CQI and rank indicator feedback are firstly mapped to a number of constellation points, e.g. according to a quadrature amplitude modulation (QAM) mapping scheme. The constellation points mapped from the CQI are then transmitted on the data symbols, by modulating/multiplying each data symbol with a corresponding constellation point. CQI includes, but not limited to Precoding Matrix Indicator (PMI), Modulation and Coding Scheme (MCS), or combinations thereof. Rank feedback is embedded in a configured subframe every T1 subframes. CQI feedback is embedded in a configured subframe every T2 subframes, where T1 is greater than T2, as described in more detail above.

A pre-defined reference signal is transmitted in the RS symbol. The pre-defined reference signal transmitted in each RS symbol can be the same. Alternatively, the pre-defined reference signals can be different in different RS symbols, provided these pre-defined reference signals are known to both the transmitter and the receiver.

As shown in FIG. 15, the eNB 1502 comprises a Processor 1509 coupled to a memory 1513 and a transceiver 1510. The memory 1513 stores applications 1508 for execution by the processor 1509. The applications 1508 could comprise any known or future application useful for managing wireless communications. At least some of the applications 1508 may direct the base-station to manage transmissions to or from the user device 1501.

Transceiver 1510 comprises an uplink Resource Manager 1512, which enables the eNB 1502 to selectively allocate uplink PUSCH resources to the user device 1501. As would be understood by one of skill in the art, the components of the uplink resource manager 1512 may involve the physical (PHY) layer and/or the Media Access Control (MAC) layer of the transceiver 1510. Transceiver 1510 includes a Receiver 1511 for receiving transmissions from various UE within range of the eNB and transmitters for transmitting data and control information to the various UE within range of the eNB.

Uplink resource manager 1512 executes instructions that control the operation of transceiver 1510. Some of these instructions may be located in memory 1513 and executed when needed. Resource manager 1512 controls the transmission resources allocated to each UE that is being served by eNB 1502 and broadcasts control information via the physical downlink control channel PDCCH. In particular, for the transmission of feedback information, eNB 1502 arranges the cyclic shifted base sequences in the time-frequency resource, as described above. The Node-B can have prior knowledge on whether feedback bits are expected in the second CQI RS or not. If the Node-B knows there are no feedback bits in the second CQI RS, then it demodulates the both CQI RS symbols to provide channel estimation for coherent demodulation of the CQI data symbols. If the Node-B expects feedback bits in the second CQI RS, then it decodes the QAM symbol carried in the second CQI RS with the channel estimation obtained from the first CQI RS. Further, after feedback demodulation and decoding on the second CQI RS, the second RS can also serve as a channel estimate for CQI data symbols, as described in more detail above.

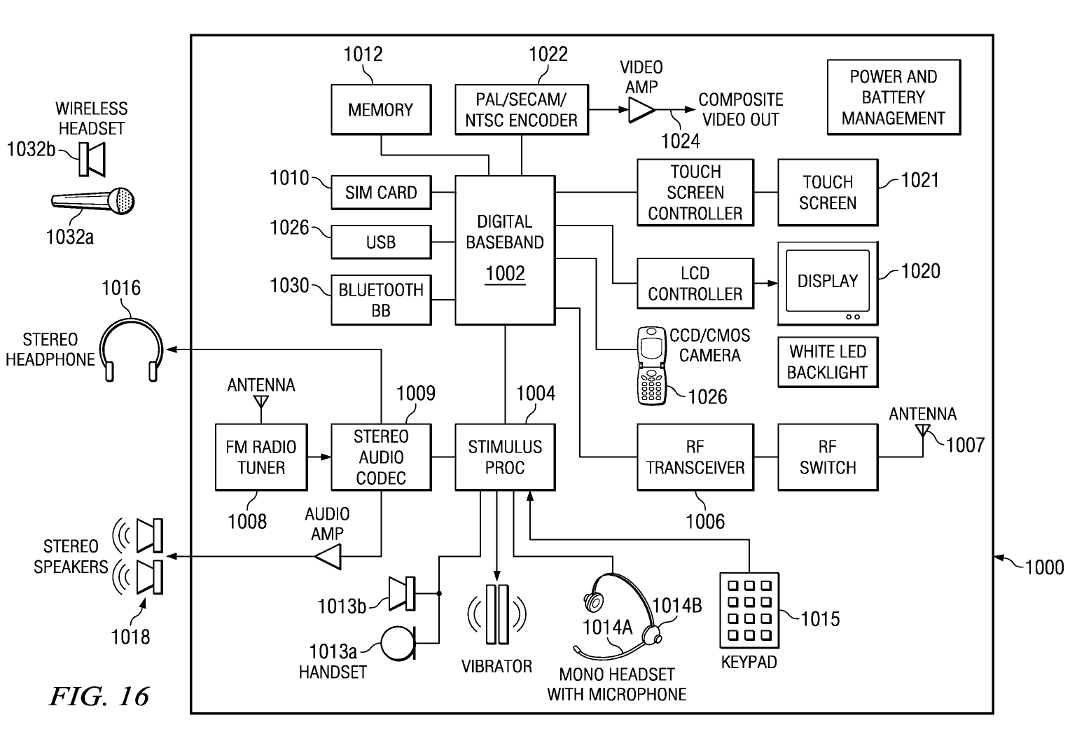

FIG. 16 is a block diagram of mobile cellular phone 1000 for use in the network of FIG. 1. Digital baseband (DBB) unit 1002 can include a digital processing processor system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 1006 includes a receiver for receiving a stream of coded data frames and commands from a cellular base station via antenna 1007 and a transmitter for transmitting a stream of coded data frames to the cellular base station via multiple antennas 1007 that support MIMO operation. Transmission of the PUSCH data is performed by the transceiver using the PUSCH resources designated by the serving eNB. In some embodiments, frequency hopping may be implied by using two or more bands as commanded by the serving eNB. In this embodiment, a single transceiver can support multi-standard operation (such as EUTRA and other standards) but other embodiments may use multiple transceivers for different transmission standards. Other embodiments may have transceivers for a later developed transmission standard with appropriate configuration. RF transceiver 1006 is connected to DBB 1002 which provides processing of the frames of encoded data being received and transmitted by the mobile UE unite 1000.

The EUTRA defines SC-FDMA (via DFT-spread OFDMA) as the uplink modulation. The basic SC-FDMA DSP radio can include discrete Fourier transform (DFT), resource (i.e. tone) mapping, and IFFT (fast implementation of IDFT) to form a data stream for transmission. To receive the data stream from the received signal, the SC-FDMA radio can include DFT, resource de-mapping and IFFT. The operations of DFT, IFFT and resource mapping/de-mapping may be performed by instructions stored in memory 1012 and executed by DBB 1002 in response to signals received by transceiver 1006.

For feedback transmission, a transmitter(s) within transceiver 1006 may be embodied as described with respect to FIGS. 2-15. In particular, as described above, for the transmission of feedback a transmission signal may comprise at least one data symbol and at least one RS symbol. An exemplary transmission signal comprising five data symbols and two RS symbols is shown in FIG. 2. Rank indicator and CQI feedback information are separately embedded in at least two different data symbols, as described above. The CQI and rank indicator feedback are firstly mapped to a number of constellation points, e.g. according to a quadrature amplitude modulation (QAM) mapping scheme. The constellation points mapped from the CQI are then transmitted on the data symbols, by modulating/multiplying each data symbol with a corresponding constellation point. CQI includes, but not limited to Precoding Matrix Indicator (PMI), Modulation and Coding Scheme (MCS), or combinations thereof. Rank feedback is embedded in a configured subframe every T1 subframes. CQI feedback is embedded in a configured subframe every T2 subframes, where T1 is greater than T2, as described in more detail above. In some embodiments, T1 may be equal to T2.

A pre-defined reference signal is transmitted in the RS symbol. The pre-defined reference signal transmitted in each RS symbol can be the same. Alternatively, the pre-defined reference signals can be different in different RS symbols, provided these pre-defined reference signals are known to both the transmitter and the receiver.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1026, or from other sources such as USB 1026. DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder unit 1022 can provide encoding according to PAL/SECAM/NTSC video standards.

As used herein, the terms “applied,” “coupled,” “connected,” and “connection” mean electrically connected, including where additional elements may be in the electrical connection path. “Associated” means a controlling relationship, such as a memory resource that is controlled by an associated port. While the invention has been described with reference to illustrative embodiments, this description is not intended to be construed in a limiting sense.

Various other embodiments of the invention will be apparent to persons skilled in the art upon reference to this description. For example, a larger or smaller number of symbols then described herein may be used in a slot. Other types of feedback may be separately embedded and transmitted in configured frames at various times. The term “frame” and “subframe” are not restricted to the structure of FIG. 2. Other configurations of frames and/or subframes may be embodied. In general, the term “frame” may refer to a set of one or more subframes.

FIGS. 2-16 illustrate various embodiments and various modes of operation. A particular embodiment may be arranged to perform all or a portion of the various modes illustrated in FIGS. 2-16.

It is therefore contemplated that the appended claims will cover any such modifications of the embodiments as fall within the true scope and spirit of the invention.

What is claimed is:

1. A method for providing feedback in a user equipment (UE), comprising:
generating a sequence of transmission time slots;
embedding a first type of feedback in every T1 transmission time slots; and
embedding a second type of feedback in every T2 transmission time slots, wherein T1 is greater than T2 and wherein the second type of feedback is derived based on the first type of feedback.

2. The method of claim 1, wherein the second type of feedback is derived based on the latest first type of feedback.

3. The method of claim 1, wherein embedding the first type of feedback comprises embedding the first type of feedback in a first N1 transmission time slots in every T1 transmission time slots, wherein 1≦N1<T1.

4. The method of claim 3, wherein embedding the first type of feedback comprises encoding the first type of feedback by a coding scheme, wherein the coding scheme is a block coding scheme, a convolutional coding scheme, or a repetition coding scheme.

5. The method of claim 1, wherein T1 and T2 are configured by a base station and signaled to the UE.

6. The method of claim 1, wherein the first type of feedback is transmission rank and the second type of feedback is channel quality indication.

7. The method of claim 1, wherein T1 is larger than T2 by a range of two to thirty two times.

8. The method of claim 1, wherein each transmission time slot comprises at least one reference signal symbol and at least one data symbol, and wherein the first type of feedback is embedded in at least one of the reference signal symbols by modulating a reference signal with the first type of feedback.

9. A method for recovering feedback at a base station from a user equipment (UE), comprising:
receiving a sequence of transmission time slots;
recovering a first type of feedback in every T1 transmission time slots; and
recovering a second type of feedback in every T2 transmission time slots, wherein T1 is greater than T2 and wherein the second type of feedback is derived based on the first type of feedback.

10. The method of claim 9, wherein recovering the first type of feedback comprises recovering the first type of feedback in a first N1 transmission time slots in every T1 transmission time slots, wherein 1≦N1<T1.

11. The method of claim 10, wherein recovering the first type of feedback comprises decoding the first type of feedback by a coding scheme, wherein the coding scheme is a block coding scheme, a convolutional coding scheme, or a repetition coding scheme.

12. The method of claim 9, wherein T1 and T2 are configured by the base station and signaled to the UE.

13. The method of claim 9, wherein T1 is larger than T2 by a range of two to thirty two times.

14. The method of claim 9, wherein each transmission time slot comprises at least one reference signal symbol and at least one data symbol, and wherein the first type of feedback is recovered in at least one of the reference signal symbols by demodulating a reference signal with the first type of feedback.

15. A user equipment apparatus for providing feedback, comprising:
circuitry for generating a sequence of transmission time slots;
circuitry operable to embed a first type of feedback in every T1 transmission time slots;
circuitry operable to embed a second type of feedback in every T2 transmission time slots, wherein T1 is greater than T2 and wherein the second type of feedback is derived based on the first type of feedback.

16. Base station apparatus for recovering feedback from a user equipment (UE), comprising:
circuitry for receiving a sequence of transmission time slots;
circuitry operable to recover a first type of feedback in every T1 transmission time slots; and
circuitry operable to recover a second type of feedback in every T2 transmission time slots, wherein T1 is greater than T2 and wherein the second type of feedback is derived based on the first type of feedback.

17. A method for providing feedback in a user equipment (UE), comprising:
generating a sequence of transmission time slots;
embedding a first type of feedback in every T1 transmission time slots; and
embedding a second type of feedback in every T2 transmission time slots, wherein T1 is equal to T2 and wherein the second type of feedback is derived based on the first type of feedback.

18. The method of claim 17, wherein embedding the first type of feedback comprises embedding the first type of feedback in a first N1 transmission time slots in every T1 transmission time slots, wherein 1≦N1<T1.

19. The method of claim 17, wherein embedding the first type of feedback comprises encoding the first type of feedback by a coding scheme, wherein the coding scheme is a block coding scheme, a convolutional coding scheme, or a repetition coding scheme.

20. The method of claim 17, wherein the first type of feedback is transmission rank and the second type of feedback is channel quality indication.
